(19) United States
(12) Patent Application Publication
(10) Pub. No.: US 2003/0120781 A1
(43) Pub. Date: Jun. 26, 2003

(54) Method and system for user initiated connectivity to a communication network

(76) Inventor: Christen K. Pedersen, Sunnyvale, CA (US)

Correspondence Address: HEWLETT-PACKARD CAMPANY, Intellectual Property Administration, P.O. Box 272400, Fort Collins, CO, 80527-2400, US

(21) Appl. No.: 10/032,245

(22) Filed: Dec. 21, 2001

(51) Int. Cl. G06F 15/16

(52) U.S. Cl. 709/227

(57) ABSTRACT

Method and system for user initiated connectivity to a communication network. Specifically, embodiments of the present invention describe a method of connection to a communication network. The method discloses the acknowledgment of an initiation of a communication interface by a user at a first electronic device. The communication interface provides network connectivity information for the first electronic device. The network connectivity information is necessary for establishing a communication path to other electronic devices through a communication network. Further, the communication interface assists the user in establishing a communication path through the communication network to a second electronic device with known network connectivity information.

### TECHNICAL FIELD

The present invention relates generally to the field of network communications. More specifically, the present invention pertains to a method of and system for a user initiated communication interface for coupling to a communication network.

### BACKGROUND ART

Network technologies allow for mobile and static electronic devices to communicate with each other through a communication network. The communication network may comprise both wirelessly enabled devices and the more conventional cable enabled devices for connection. For example, printers, personal digital assistants (PDAs) or handheld computers, personal desktop computers, fax machines, keyboards, joysticks, and virtually any other digital electronic device can be coupled together as part of a communication network.

Currently, network based connections between devices are cumbersome to establish, and usually require some assistance from the information technology (IT) department of a company. In particular, in order to establish a connection between two devices that are coupled to a communication network, some special knowledge and detailed information (e.g., Internet Protocol (IP) addresses, or device identification in a corporate directory) are required to setup the connection.

For example, in an office environment, a user of a PDA may have a document ready for printing. The PDA is located in the same room as a printer. Moreover, both the PDA and the printer are coupled to a communication network that includes the office local area network servicing the printer. The PDA may be coupled to the communication network via a wireless connection and/or some other cable network. However, a network based connection between the PDA and the printer, is difficult to set up without the proper information and requisite networking knowledge.

This connection information is difficult to obtain, and is not readily accessible to the ordinary user of an electronic device. In other words, it requires some expertise to extract the connection information. Moreover, some information is dynamic and constantly changes over time. For example, the IP address of a particular electronic device can be dynamically assigned and changes each time that device couples to the communication network. As such, network based connections are almost never established in an ad-hoc manner, and are impractical for all but the most stable resource needs in an office environment, for example, coupling to a shared printer, or storage device.

One prior solution is provided through a logical network infrastructure. The drawback to the logical network is that devices that may be geographically located in the same location may not be located in a logical local network. For example, Microsoft's ® Universal Plug and Play (UPnP) is an architecture for pervasive peer-to-peer network connectivity of electronic devices of all form factors (e.g., personal computers, wireless devices, intelligent appliances, etc.). The UPnP architecture is a distributed, open networking architecture that leverages TCP/IP and the Web to enable seamless proximity networking among networked devices in any environment.

However, the limitation of UPnP lies within its logical nature. Only devices within a logical network will be included within a UPnP architecture for possible communication. As such, only devices that are located within a certain number of hops (e.g., switches, hubs, etc.) are included within the UPnP architecture. Unfortunately, even if the devices are within a local geographic location (e.g., an office), these devices are frequently outside the UPnP architecture because they are separated by more than the prescribed number of hops. For example, a wirelessly enabled PDA that is located in the same office as a printer, may be separated by five or more hops from the printer through the communication network. As such, a communication path between the PDA and the printer would not be established if the logical network is limited to three hops.

Moreover, in a UPnP architecture, the number of hops cannot be arbitrarily increased. By increasing the number of hops in a logical architecture, the number of possibly connected devices greatly increases. This high number of devices within a logical architecture would be cumbersome t o establish and maintain. Also, selection between an larger group of possibly connectable devices by a user would be increasingly more difficult. Even without increasing the number of hops, it is possible that a user would have to select between hundreds and even thousands of printers on the logical architecture. This makes it difficult to identify and select the local resources.

Another prior solution is to add a common physical layer between the two devices through which they can communicate. For example, a common physical interface, such as, infrared or Bluetooth, could be added to both the devices. As such, even though both devices are connected to a communication network, a separate connection is made over a new physical connection between the two devices through the additional physical layer. This necessarily requires additional hardware (e.g., radio and beacons) and software to be loaded onto both devices for them to communicate. As a solution, the cost of including the necessary hardware and software for an additional physical layer may be cost prohibitive.

### DISCLOSURE OF THE INVENTION

Embodiments of the present invention describe a method and system for providing user initiated connectivity to a communication network. Specifically, embodiments of the present invention describe a method of connection. The method discloses the acknowledgment of an initiation of a communication interface by a user at a first electronic device. The communication interface provides network connectivity information for the first electronic device. The network connectivity information is necessary for establishing a communication path to other electronic devices through a communication network. Further, the communication interface assists the user in establishing a communication path through the communication network to a second electronic device with known network connectivity information.

Other embodiments of the present invention describe a communication system upon which the method of user initiated connectivity is implemented. A plurality of electronic devices is coupled to a communication network. Each of the plurality of electronic devices is capable of providing network connectivity information, when a communication interface is initiated by a user, that is necessary for establishing a communication path to other electronic devices that are coupled to the communication network.

### BRIEF DESCRIPTION OF THE DRAWINGS

The above and other objects and advantages of the present invention will be more readily appreciated from the following detailed description when read in conjunction with the accompanying drawing, wherein:

FIG. 1 is a diagram of a communication network having devices with user initiated communication interface capabilities, in accordance with one embodiment of the present invention.

FIG. 2 is a block diagram illustrating the components of an electronic system capable of supporting a user initiated communication interface, in accordance with one embodiment of the present invention.

FIG. 3 is a block diagram illustrating a prominent, physical selector button for initiating a communication interface, in accordance with one embodiment of the present invention.

FIG. 4 is a block diagram illustrating a software enabled selector button for initiating a communication interface, in accordance with one embodiment of the present invention.

FIG. 5 is a flow diagram illustrating steps in a method for supporting a user initiated communications interface for coupling to a communication network, in accordance with one embodiment of the present invention.

The drawings referred to in this description should be understood as not being drawn to scale except if specifically noted.

### BEST MODES FOR CARRYING OUT THE INVENTION

Reference will now be made in detail to embodiments of the present invention, a method and system for a user initiated communication interface for coupling to a communication network, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims.

Furthermore, in the following detailed description of the present invention, numerous specific details are set forth in order to provide a thorough understanding of the present invention. However, it will be recognized by one of ordinary skill in the art that the present invention may be practiced without these specific details. In other instances, well known methods, procedures, components, and circuits have not been described in detail as not to unnecessarily obscure aspects of the present invention.

Some portions of the detailed descriptions which follow are presented in terms of procedures, steps, logic blocks, processing, and other symbolic representations of operations on data bits that can be performed on computer memory. These descriptions and representations are the means used by those skilled in the data processing arts to most effectively convey the substance of their work to others skilled in the art. A procedure, computer executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “acknowledging,” or “prompting,” or “assisting,” or “providing,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

### USER INITIATED CONNECTIVITY TO A COMMUNICATION NETWORK

Accordingly, embodiments of the present invention provide a method and system for supporting a user initiated communication interface for coupling devices across or through a communication network. The present invention allows the user to exercise control over the establishment of communication paths through a communication network. In addition, embodiments of the present invention make network connectivity practical for a wider audience.

Some embodiments of the present invention are implemented on computer-readable and computer-executable instructions which reside, for example, in computer-readable media of a computer system. The computer system has sufficient hardware (e.g., processor, memory, display, etc.) to support a user initiated communication interface for coupling to a communication network.

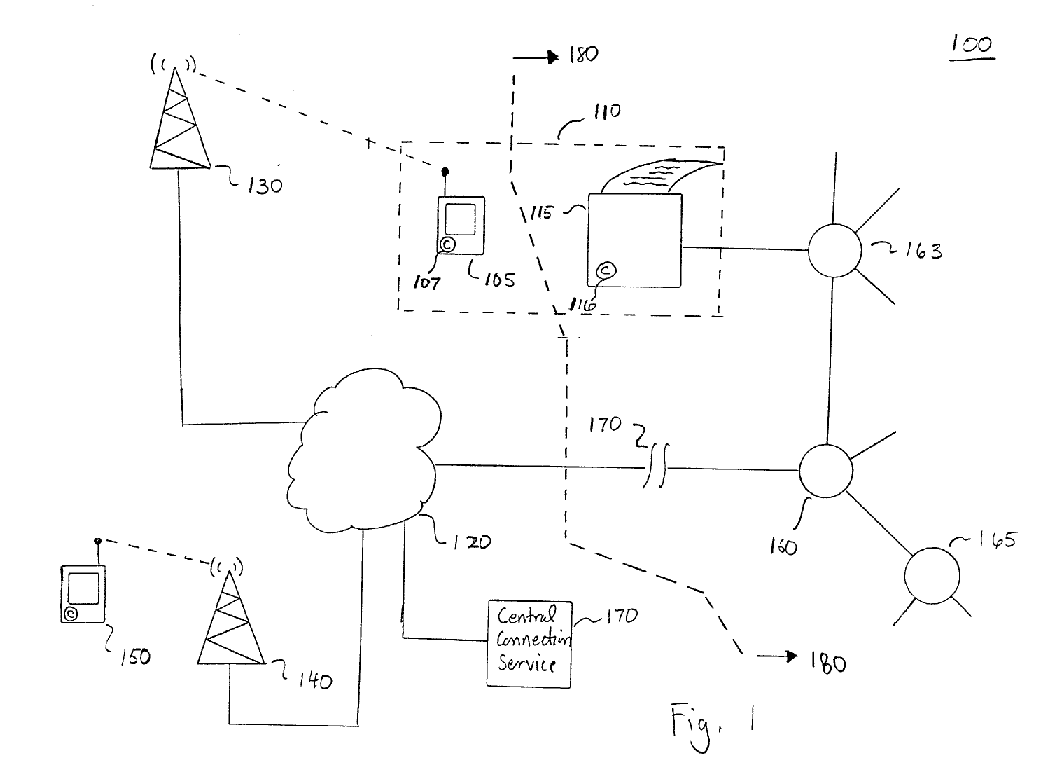

Referring now to FIG. 1, a communication architecture 100 comprises wirelessly enabled devices as well as the conventional, cable enabled devices, in accordance with one embodiment of the present invention. Architecture 100 includes a local area network (LAN) 180. The architecture 100 and the LAN 180 shown in FIG. 1 supports numerous switching devices, including switching devices 160, 163, and 165 and other switching devices that are not shown. Switching devices 160, 163, and 165 can be switches, routers, hubs, etc. Furthermore, in another embodiment, the network architecture 100 is comprised of a plurality of devices each of which support user initiated connectivity to the network through a communication interface.

The LAN 180 can support a group of computers and other devices for communication purposes. The LAN is coupled to an external communication network 120, in accordance with one embodiment. A firewall 170 is placed between a communication network 120 and the LAN 180 to protect the LAN 180 from external threats. The LAN 180 could comprise a printer 115 in an office environment 110 within the organization supported by the LAN 180.

The printer 115 is equipped with sufficient hardware and software to implement a user initiated communication interface for network connectivity. The printer 115 includes a physical, button selector 116 for initiating the communication interface, in one embodiment. Other embodiments of the present invention provide for other selectors, such as, software enabled selectors, etc.

The office environment 110 includes an electronic device 105. Device 105 may be a personal digital assistant (PDA) 105 that is mobile. PDA 105 is also equipped with sufficient hardware and software to implement a user initiated communication interface for network connectivity. The PDA 105 includes a physical, button selector 107 for initiating the communication interface located on the PDA 105.

The wirelessly enabled PDA 105 is coupled to the communication network 120 through a tower 130. The communication network 120 is also coupled to a central connection service 170 and another tower 140. Tower 140 supports wireless communication with a PDA 150 that is also equipped with sufficient hardware and software to implement a user initiated communication interface for network connectivity.

Furthermore, network architecture 100 includes a central connection service 170 that is coupled to the communication network 120. The connection service 170 is capable of monitoring initiations of communication interfaces of devices that are coupled to the communication network 120.

Embodiments of the present invention are well suited to supporting a communication network 120 that is a LAN, or a wide area network, or a Internet network, or any network capable of supporting multiple computer systems and related devices.

In the network architecture 100, any device within the architecture 100 is coupled to the communication network 120 through various wireless and conventional, cable connection, in accordance with one embodiment of the present invention. As such, any device located within the architecture 100 can communicate with any other device located in architecture 100 through the communication network 120. For example, the PDA 105 can communicate with printer 115 through the communication network 120. The PDA 105, with the proper support drivers can send a print job through the communication network 120 to the printer 115 in order to print a hardcopy. Also, PDA 105 can communicate with PDA 150 since they are coupled to the same communication network 120.

Embodiments of the present invention are well suited to various communication standards for communication. For example, embodiments of the present invention support standards, such as, Ethernet, IEEE 1284 (parallel printer connector, Universal Serial Bus (USB), RS232, IEEE 1394, Global System for Mobile Communications (GSM), Personal Communications Services (PCS), Code Division Multiple Access (CDMA) for cellular radio, etc. Provided that two devices are engineered to comply with an existing specification or particular implementation of a specification, large numbers of devices within a network (e.g., network architecture 100) can communicate with each other provided they have the same industry-standard connection capability and support drivers.

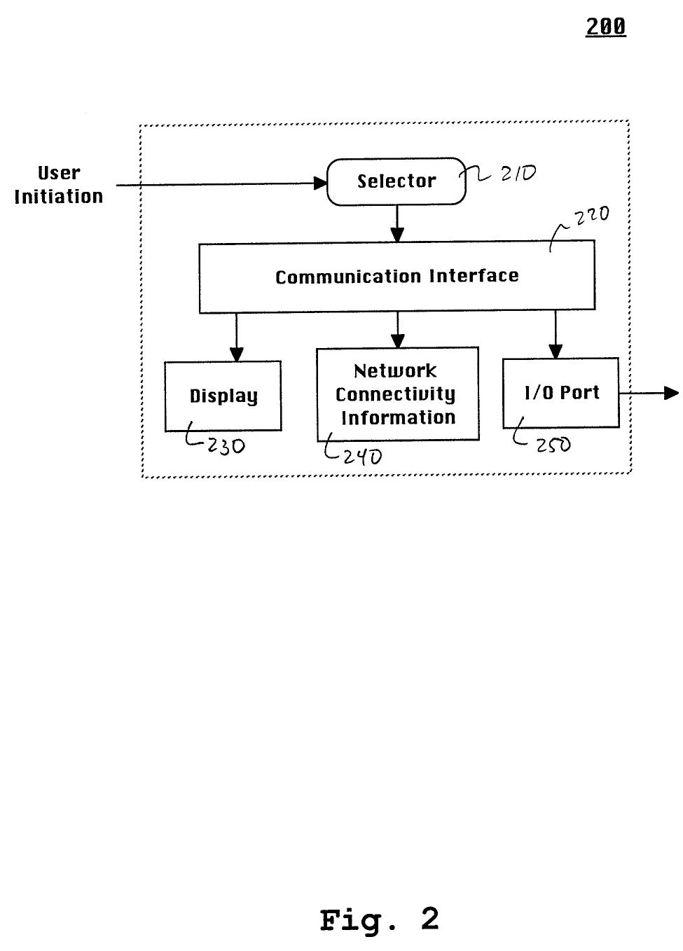

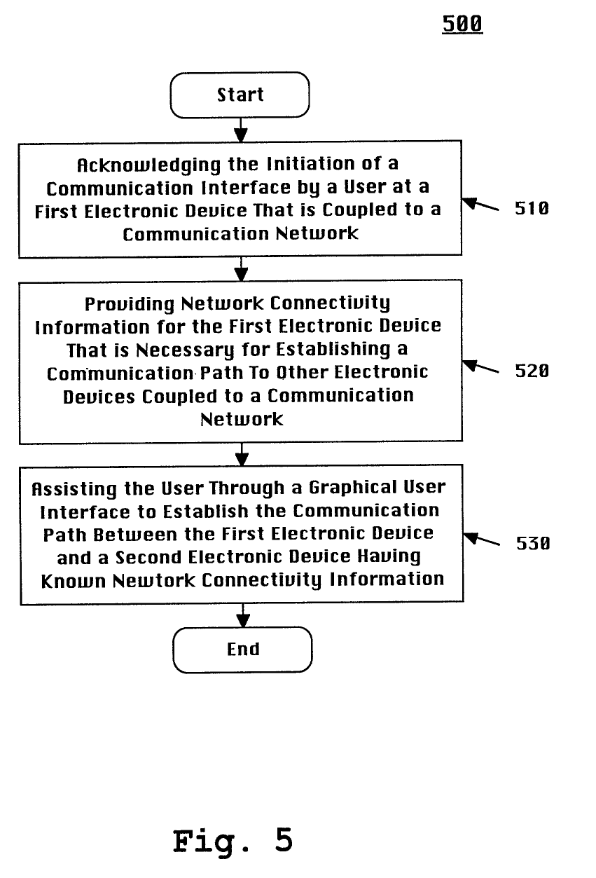

The flow chart in FIG. 5 in combination with FIGS. 2, 3, and 4 disclose a method for user initiated connectivity to a communication network, in accordance with one embodiment of the present invention. In one embodiment, instead of having localized devices automatically connect to one another, the user initiated establishment of a communication path allows the user to control connectivity issues.

Referring now to FIG. 2, a block diagram of an exemplary electronic device 200 that supports a user initiated communication interface for network connectivity is shown, in accordance with one embodiment of the present invention. The device 200 can be any device that is capable of communicating through a communication network. As such, the device 200 can be a printer, personal digital assistants (PDAs) or handheld computers, personal desktop computers, fax machines, keyboards, joysticks, and virtually any other digital electronic device.

FIG. 2 illustrates a selector 210 that initiates a communication interface 220. The communication interface 220 is able to access network connectivity information necessary to establish a communication path between the device 200 and other devices couple to a communication network. In addition, the communication interface 220 is coupled to a display 230 for displaying the network connectivity information. In another embodiment, the communication interface 220 is able to support other means of displaying connectivity information, such as, via a hardcopy. Also, the communication interface 220 is coupled to an Input/Output (I/O) port 250 for communicating with the communication network.

Referring now to FIG. 5, flow chart 500 illustrates steps in a method for providing connectivity to a communication network, in accordance with one embodiment of the present invention. The communication interface, when initiated by a user, provides pertinent network connectivity information for an associated electronic device for establishing communication paths to other devices over the communication network.

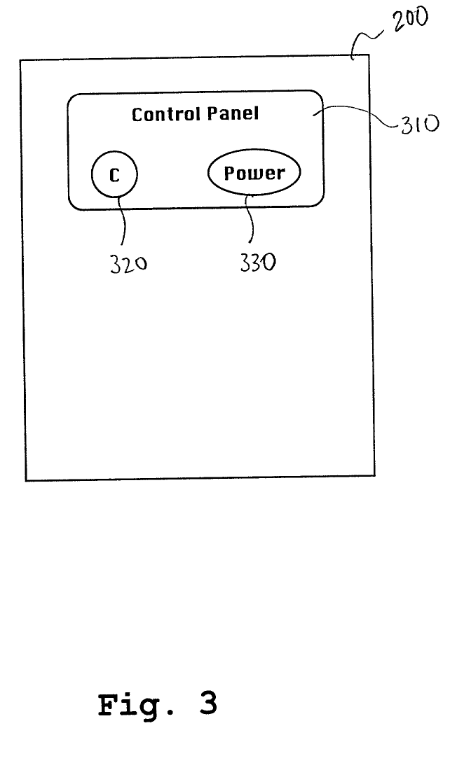

In step 510, the present embodiment acknowledges the initiation of a communication interface by a user at a first electronic device. The first electronic device is coupled to the communication network. To illustrate, electronic device 200 in FIG. 2 includes a selector 210. The selector 210 can be a physical, button interface in one embodiment. For example, FIG. 3 illustrates a block diagram of the electronic device 200 with a prominent physical, button 320. In another embodiment, the device 200 has other buttons situated on a control panel 310, such as, the power control button 330. The button 320 on device 200, when pressed, initiates the communication interface that provides network connectivity information 240 for the device 200, and provides connection to the communication network. The button 320 is distinguished by the letter “C” to indicate its connection capabilities, in accordance with one embodiment of the present invention. For example, in architecture 100, PDA 105 has a “C” connection button 107 and the printer 115 has a “C” connection button 116.

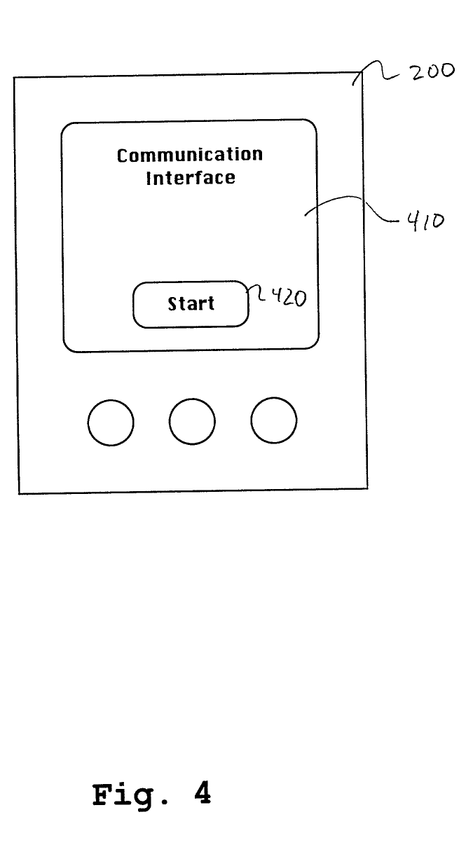

In another embodiment, the selector 210 can be a software enabled button interface. FIG. 4 illustrates a block diagram of the electronic device 200 with a software enabled button 420. The device 200 includes a display 410 that shows an interface to the communication interface features of the device 200. The display 410 presents a start button 420 to a user of the device 200. By selecting the start button 420 through any means (e.g., tapping on the button with a stylus, hitting an enter button, etc.) the communication interface is initiated. Again the communication interface provides connectivity information for the device 200, and provides connection to the communication network.

Referring now back to FIG. 2, the selector 210 is shown to be user initiated. Instead of automatically coupling to every device that is within a logical network, a user initiates establishing a communication path between two devices through a communication network. As such, a user initiated connection ensures that communication paths between two devices does not unnecessarily occur. Instead, the user controls when and with which devices to establish a communication path.

The engagement of the selector 210 initiates the communication interface 220 of electronic device 200. Furthermore, the communication interface is coupled to a display 230 of the device 200 for providing network connectivity information and a graphical user interface (GUI) for assisting in the establishment of a communication path between device 200 and another device that is coupled to the communication network 200.

In addition, the communication interface can be coupled to any component that is capable of transferring network connectivity information. For example, in a printer, the communication interface 220 may print out a hard copy of the network connectivity information needed by another device for establishing a communication path through a communication network between the two devices.

Returning now to flow chart 500, the present embodiment provides network connectivity information for the first electronic device that is necessary for establishing a communication path to other electronic devices coupled to the communication network, in step 520. For example, in FIG. 2, as previously discussed, the communication interface 220 is capable of extracting network connectivity information from device 200 for the purposes of establishing a communication path between device 200 and another device over a communication network. In one embodiment, the network connectivity information is an Internet Protocol (IP) address. In another embodiment, the network connectivity information is a corporation assigned device identification.

In step 530, the present embodiment assists the user through a graphical user interface to establish a communication path between the first electronic device and a second electronic device that is coupled to the communication network. In one embodiment, the second electronic device has known network connectivity information that could have been obtained using the techniques disclosed in embodiments of the present invention. In another embodiment, the GUI provides general instructions for establishing a communication path to any electronic device coupled to the communication network.

The inclusion of a user interface that is capable of prompting the user for information that is necessary for establishing a communication path between the first device and the second device over a communication network makes the process of coupling two devices much simpler and more practical for a wider audience. Instead of knowing beforehand what to do and how to establish a communication path, the GUI has the intelligence to understand what is needed and prompts the user at one of the devices for the requisite information at the proper time in order to establish the communication path between the two devices.

For example, referring back to FIG. 1, in the case where a user of the PDA 105 would like to establish a communication path between PDA 105 and the printer 115, the GUI at the PDA 105 would walk the user through the necessary procedures to establish the communication path. In one embodiment, what is needed is the IP address of both the devices 105 and 115. By pressing the “C” buttons on both devices 105 and 115, the requisite network connectivity information is provided at each device. Thereafter, the user may elect to implement the additional features of the communication interface, at one of the two devices, and implement the GUI for establishing the communication path between the two devices. The GUI will prompt the user at the proper time for inputting one or both IP addresses, as well as other pertinent connectivity information, of the two devices to help establish the communication path between the two devices.

Although in the office environment 110, the same user can press both the “C” buttons 107 and 116 for the requisite connectivity information for both devices 105 ad 115, embodiments are well suited to establishing paths between two devices that are not located within the same geographical location. For example, PDA 105 could communicate with PDA 150 through the communication network 120. This would entail communicating with the other user associated with PDA 150 in order to understand and know what the other devices networking information is for inputting into the electronic device 105.

In another embodiment, the GUI for assisting the user to establish a communication path includes some networking wizardry. In this way, the embodiment avoids having the user go out and search for remote resources, and having the user obtain the necessary connectivity information regarding those other remote resources. Instead, the networking wizardry, through the GUI, is able to locate local resources and determine the necessary information needed to set up a communication path between the device where the GUI is located and the other local resources on the communication network. The user need only look at a list of available resources for connection and select the remote device needed. In one embodiment, the remote resources are generally localized with regards to the device including the networking wizardry.

Referring now back to FIG. 1, a central connection server 170 is located within the networking architecture 100, in accordance with one embodiment of the present invention. The central connection service 170 is coupled to each of the plurality of devices within the architecture 100 that supports the user initiated connectivity to the communication network 120 as disclosed in embodiments illustrated by flow chart 500.

The central connection service 170 is capable of monitoring initiations of the communication interfaces at each of the plurality of electronic devices with the aforementioned network connection features. In addition the central connection service 170 is able to receive necessary connectivity information associated with the device that is initiating the communication interface. In one embodiment, the connection service 170 is able to receive the connectivity information from a device that is generated by the communication interface when initiated by a user at that device.

In another embodiment, the central connection service 170 is able to place devices within a logical network, and search for devices within a logical network. As such, the connectivity information needed may simple be a unique device identification (device ID). By notifying a first device of the device ID of the second device, a central connection service 170 is able to logically locate the second device on the communication network for the purposes of establishing a communication path electronically between the first and second devices.

Furthermore, the central communication service 170 is able to automatically establish a communication path between two devices when their associated communication interfaces have been initiated under a certain condition. In one embodiment, the condition is a period of time. If two communication interfaces at a first device and a second device have been initiated within a certain period of time, then the central communication server 170 would automatically establish a communication path between the first and second devices.

For example, referring back to FIG. 1, a PDA 105 and a printer 115 is located within the same office environment. A user would like to establish a communication path between the PDA 105 and the printer 115 in order to print a file located on the PDA 105 at the printer 115. The user would initiate the respective communication interfaces at both the PDA 105 and the printer 115. Since the two devices are located within the same location, the interfaces would be initiated within a minute of each other, and possibly within seconds of each other. The central communication service 170 is able to detect the time difference between the two initiations. If the time difference falls within a predefined period, then the service 170 will automatically gather up the requisite connectivity information from both devices and establish a communication path between the two devices.

In another embodiment, the central communication service 170 automatically connects two electronic devices under a condition of geographic location. For example, in the example illustrated above where a PDA 105 and a printer 115 are located within the same location, the central communication service 170 is able to determine the location of the two devices upon their associated initiation of their respective communication interface. If their location falls within a certain geographic condition, then the service 170 will automatically establish a communication path between the two devices. Embodiments of the present invention are well suited to various geographic conditions, such as, locations within a city block, locations within a block on a telephone network, locations that are within a certain distance of each other as determined by global position satellite (GPS) positioning, locations that fall within a certain radius of a central location, etc.

While the methods of embodiments illustrated in flow chart 500 show specific sequences and quantity of steps, the present invention is suitable to alternative embodiments. For example, not all the steps provided for in the method are required for the present invention. Furthermore, additional steps can be added to the steps presented in the present embodiment. Likewise, the sequences of steps can be modified depending upon the application.

A method and system for a user initiated communication interface for network connectivity, is thus described. While the present invention has been described in particular embodiments, it should be appreciated that the present invention should not be construed as limited by such embodiments, but rather construed according to the below claims.

While the invention has been illustrated and described by means of specific embodiments, it is to be understood that numerous changes and modifications may be made therein without departing from the spirit and scope of the invention as defined in the appended claims and equivalents thereof.

What is claimed is:

1. A communication system comprising:
a communication network; and
a plurality of electronic devices coupled to said communication network, each of said plurality of electronic devices including a selector for initiating a user initiated communication interface that provides network connectivity information necessary for establishing communication paths to other electronic devices coupled to said communication network.

2. The communication system as described in claim 1, further comprising:
a central communication interface for monitoring initiations of said communication interfaces by said plurality of electronic devices, and for establishing a communication path automatically between a first and second electronic device of said plurality of electronic devices when their associated first and second communication interfaces, respectively, have been initiated under a condition.

3. The communication system as described in claim 2, wherein said condition is initiating said first and second communication interfaces within a period of time.

4. The communication system as described in claim 2, wherein said condition is initiating said first and second communication interfaces within a geographical location.

5. The communication system as described in claim 1, wherein one of said plurality of electronic devices is a mobile device.

6. The communication system as described in claim 1, wherein one of said plurality of electronic devices is a personal digital assistant (PDA).

7. The communication system as described in claim 1, wherein said selector is a button.

8. The communication system as described in claim 1, wherein said selector is a software enabled selector located on a display of associated electronic devices.

9. The communication system as described in claim 1, wherein each of said plurality of electronic devices comprise a graphical user interface for assisting users to establish said communication paths over said communication network.

10. The communication system as described in claim 1, wherein said communication network is a wide area network.

11. A method of connection comprising:
providing a communication interface on an electronic device coupled to a communication network that when initiated by a user provides pertinent network connectivity information necessary for establishing communication paths with other devices coupled to said communication network.

12. The method of connection as described in claim 11, further comprising:
providing said communication interface universally on a plurality of electronic devices coupled to said communication network; and
providing pertinent network connectivity information for electronic devices upon initiating their respective communication interfaces for establishing said communication paths with other devices coupled to said communication network.

13. The method of connection as described in claim 12, further comprising:
automatically establishing a communication path between a first and second electronic device when their associated first and second communication interfaces, respectively, have been initiated under a condition.

14. The communication system as described in claim 13, wherein said condition is initiating said first and second communication interfaces within a period of time.

15. The communication system as described in claim 13, wherein said condition is initiating said first and second communication interfaces within a geographical location.

16. The method of connection as described in claim 11, wherein said network connectivity information is a device identification (ID).

17. The method of connection as described in claim 11, assisting said user of said electronic device through a graphical user interface to establish a communication path between said electronic device and a second electronic device chosen by said user, said second electronic device located on said communication network.

18. The method of connection as described in claim 17, wherein c) further comprises:
providing a set of possible connections to other known devices located on said communication network for selection by said user.

19. A method of connection comprising:
a) at a first electronic device, acknowledging the initiation of a communication interface by a user, said first electronic device coupled to a communication network;
b) providing network connectivity information for said first electronic device, said network connectivity information necessary for establishing communication paths to other electronic devices coupled to said communication network.

20. The method of connection as described in claim 19, wherein b) further comprises:
providing said network connectivity information on a display of said electronic device.

21. The method of connection as described in claim 19, wherein b) further comprises:
providing a hard copy of said information.

22. The method of connection as described in claim 19, wherein a) further comprises:
acknowledging the engagement of a physical selector located on said first electronic device to initiate said communication interface.

23. The method of connection as described in claim 22, wherein said physical selector is a button.

24. The method of connection as described in claim 19, wherein a) further comprises:
acknowledging the engagement of a software enabled selector located on a display of said electronic device to initiate said communication interface.

25. The method of connection as described in claim 19, further comprising:
c) assisting said user of said first electronic device through a graphical user interface to establish a communication path between said first electronic device and a second electronic device chosen by said user, said second electronic device located on said communication network.

26. The method of connection as described in claim 25, wherein c) further comprises:
providing a set of possible connections to other known devices located on said communication network for selection by said user.

27. The method of connection as described in claim 25, wherein c) further comprises:
prompting said user of said electronic device for other network connectivity information from said second electronic device obtained by initiating a second communication interface at said second electronic device.

28. The method of connection as described in claim 19, wherein said network connectivity information is an internet protocol (IP) address.

29. A computer system comprising:
a processor; and
a computer readable memory coupled to said processor and containing program instructions that, when executed, implement a method of connection comprising:
providing a communication interface on an electronic device coupled to a communication network that when initiated by a user provides pertinent network connectivity information necessary for establishing communication paths with other devices coupled to said communication network.

30. The computer system as described in claim 29, wherein said method further comprises:
providing said communication interface universally on a plurality of electronic devices coupled to said communication network; and
providing pertinent network connectivity information for electronic devices upon initiating their respective communication interfaces for establishing said communication paths with other devices coupled to said communication network.

31. The computer system as described in claim 30, wherein said method further comprises:
automatically establishing a communication path between a first and second electronic device when their associated first and second communication interfaces, respectively, have been initiated under a condition.

32. The computer system as described in claim 31, wherein said condition is initiating said first and second communication interfaces within a period of time.

33. The computer system as described in claim 31, wherein said condition is initiating said first and second communication interfaces within a geographical location.

34. The computer system as described in claim 29, wherein said network connectivity information is a device identification (ID).

35. The computer system as described in claim 29, wherein said method further comprises:
assisting said user of said electronic device through a graphical user interface to establish a communication path between said electronic device and a second electronic device chosen by said user, said second electronic device located on said communication network.

36. The computer system as described in claim 35, wherein c) of said method further comprises:
providing a set of possible connections to other known devices located on said communication network for selection by said user.
